(19) United States
(12) Patent Application Publication
(10) Pub. No.: US 2015/0047509 A1
(43) Pub. Date: Feb. 19, 2015

(54) Capsule Identification System

(71) Applicant: 2266170 Ontario Inc., Mississauga (CA)

(72) Inventors: Liberatore A. Trombetta, Ancaster (CA); Paul Ern-Chang Yang, Pickering (CA)

(21) Appl. No.: 14/460,488

(22) Filed: Aug. 15, 2014

Related U.S. Application Data
(60) Provisional application No. 61/866,264, filed on Aug. 15, 2013.

(51) Int. Cl. A47J 31/44; A47J 31/40; B65D 85/804

(52) U.S. Cl. CPC A47J 31/4492; B65D 85/8043; A47J 31/407
USPC 99/283; 426/115

(57) ABSTRACT

A capsule and capsule machine are provided for preparing product from capsules. The capsule includes a body that defines an interior space with an opening. Ingredients are disposed within the interior space for preparing a desired product. A cover is disposed over the opening. A visual tag is disposed on at least one of the body and cover. The machine includes a brew chamber adapted to receive a capsule and a reader adapted for reading a visual tag disposed on a capsule when the capsule is disposed in the brew chamber. An injection system is provided for injecting a fluid into the capsule and a controller is provided for controlling the injection system based at least in part by information identified by the reader. A capsule identification system is also provided comprising a plurality of capsule machines and interested parties connected via a remote server.

### FIELD

This specification relates to capsules and capsule machines, for preparing a consumable product, and in particular to a capsule identification system for such capsules and capsule machines.

### BACKGROUND

The following background discussion is not an admission that anything discussed below is citable as prior art or common general knowledge. The documents listed below are incorporated herein in their entirety by this reference to them.

Single serve capsules for use in machines to prepare a desired consumable product are becoming increasingly popular. Such capsules come in a variety of formats containing ingredients for producing products such as coffee, tea, hot chocolate or soup.

Capsule machines typically include an injection system for injecting a fluid, such as hot water, into a capsule for mixing with ingredients disposed within the capsule. A dispensing system is also provided to dispense the prepared product from the capsule for delivery to a receptacle such as a user's cup or bowl.

It is known to have an identification system that allows certain information regarding the capsule to be identified by the capsule machine. An example of such an identification system is the barcode applied to the lid of Tassimo™ capsules. The barcode is adapted to be read by a barcode reader disposed on the capsule machine when the capsule is loaded into the machine. A controller then controls operation of the machine in accordance with the information identified by the reader from the barcode on the capsule.

A problem with conventional capsule identification systems is that they require the capsule to be properly oriented within the capsule machine. The Tassimo™ capsule for example must be loaded into the machine with the barcode disposed at a location where it may be read by the barcode reader.

Another problem with conventional capsule identification systems is that they occupy a larger than desired amount of space on the surface of the capsule. This occupied space could preferably be utilized for providing branding or consumer information.

Another problem with conventional capsule identification systems is that they detract from the brand or consumer information that may be provided on the capsule.

There is a need for an improved capsule identification system for use with capsules and capsule machines that addresses one or more of the above problems or otherwise addresses deficiencies in current systems.

### SUMMARY

In one aspect the invention provides a capsule, for use in a machine for preparing consumable products from capsules, said capsule comprising:

a body defining an interior space with an opening;

ingredients disposed in said interior space for preparing a desired product;

a cover disposed over said opening; and

a visual tag disposed on at least one of said body and said cover, said visual tag containing information concerning said capsule that may be read by a reader disposed on the machine.

In another aspect the invention provides a capsule machine for preparing consumable products from capsules, said capsule machine comprising:

a brew chamber adapted to receive a capsule;

a reader adapted for reading a visual tag disposed on a capsule when said capsule is disposed in said brew chamber;

an injection system for injecting a fluid into said capsule; and

a controller for controlling said injection system, said controller being in communication with said reader for receiving and processing information identified by said reader.

In another aspect the invention provides a capsule identification system comprising:

a) a plurality of machines adapted for preparing consumable products from capsules, each said machine including (i) a tag reader that is adapted to read a tag disposed on a capsule and (ii) a controller in communication with said tag reader, said controller being adapted for controlling one or more operations of said machine based on information including information received from said tag reader

b) one or more interested parties that are in a position to provide or receive information concerning said capsules or said machine; and

c) one or more remote servers adapted for communicating information between said plurality of machines and said one or more interested parties.

Other aspects and features of the teachings disclosed herein will become apparent, to those ordinarily skilled in the art, upon review of the following description of the specific examples of the specification.

### DRAWINGS

The drawings included herewith are for illustrating various examples of articles, methods, and apparatuses of the present specification and are not intended to limit the scope of what is taught in any way. For simplicity and clarity of illustration, where considered appropriate, reference numerals may be repeated among the drawings to indicate corresponding or analogous elements.

FIG. 1 is a perspective view of a capsule in accordance with the present invention;

FIG. 2 is a sectional view of the capsule of FIG. 1;

FIG. 3 is a top view of the lid of the capsule of FIG. 1;

FIG. 4 is an enlarged view of a visual tag disposed on the capsule of FIG. 1;

FIG. 5 is a schematic view of a capsule machine in accordance with the present invention;

FIG. 6 is a schematic diagram of a capsule identification system including a remote server; and

FIG. 7 is a schematic view of a capsule machine in accordance with another embodiment of the present invention.

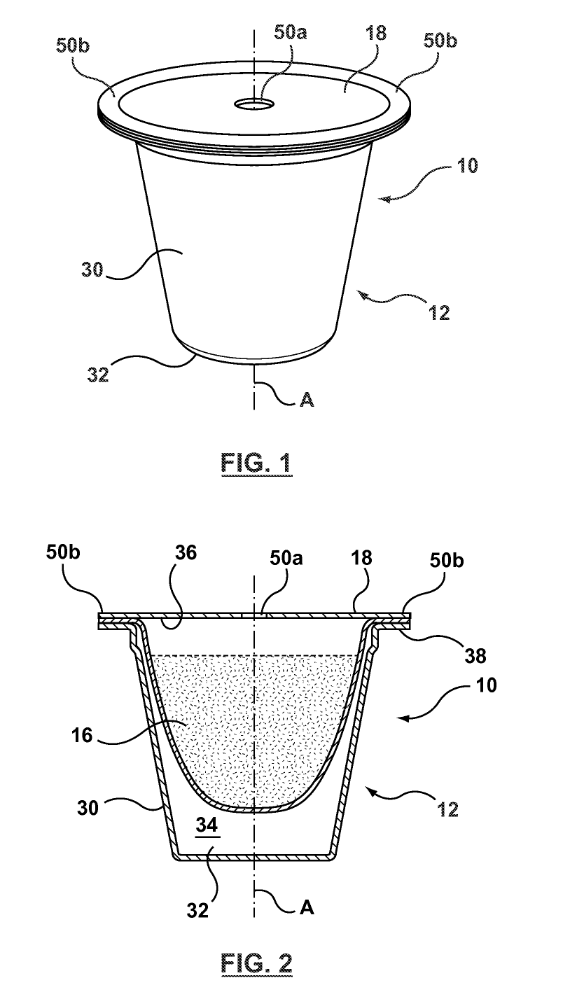

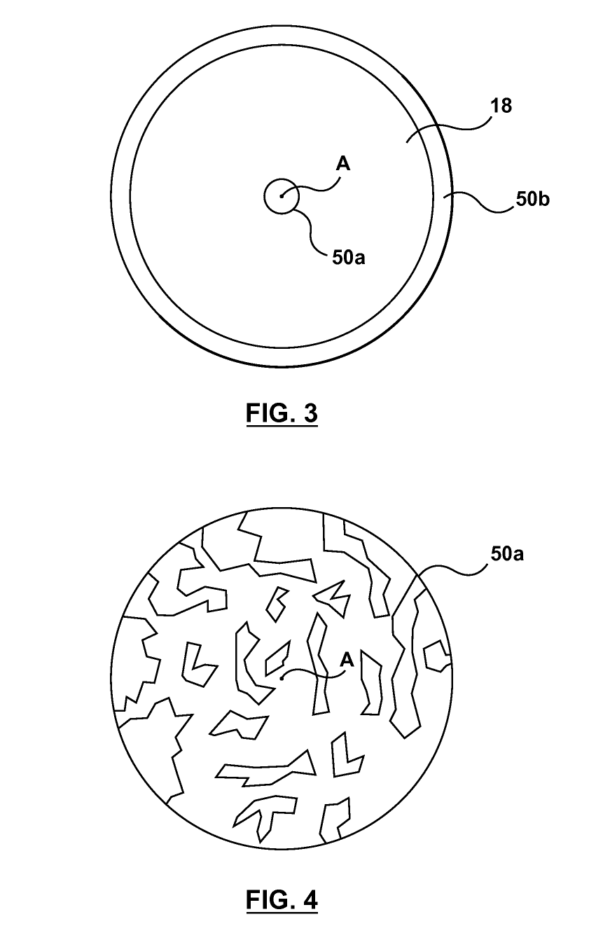

### DESCRIPTION OF VARIOUS EMBODIMENTS

Various apparatuses or methods will be described below to provide examples of the claimed invention. The claimed invention is not limited to apparatuses or methods having all of the features of any one apparatus or method described below or to features common to multiple or all of the apparatuses described below. The claimed invention may reside in a combination or sub-combination of the apparatus elements or method steps described below. It is possible that an apparatus or method described below is not an example of the claimed invention. The applicant(s), inventor(s) and/or owner(s) reserve all rights in any invention disclosed in an apparatus or method described below that is not claimed in this document and do not abandon, disclaim or dedicate to the public any such invention by its disclosure in this document.

A capsule in accordance with the present invention is shown generally at 10 in the figures. Capsule 10 includes a body 12, filter 14 (when required), ingredients 16 and cover 18. Capsule may be sized to provide a single serving of a desired product or multiple servings.

Ingredients 16 include soluble and/or insoluble ingredients that are a precursor to forming a desired product. Soluble ingredients may include coffee, chocolate, soup stock or other ingredients in powdered, crystallized or other forms adapted for solubility or contained within a soluble film or pouch. Insoluble ingredients may include tea leaves, coffee grounds, herbs or other ingredients adapted for forming a consumable product by extraction or infusion. Ingredients 16 may also include active ingredients (eg foaming agents), natural health additives, regulated drugs, alcohol or other soluble or insoluble ingredients that are a precursor to forming a desired product.

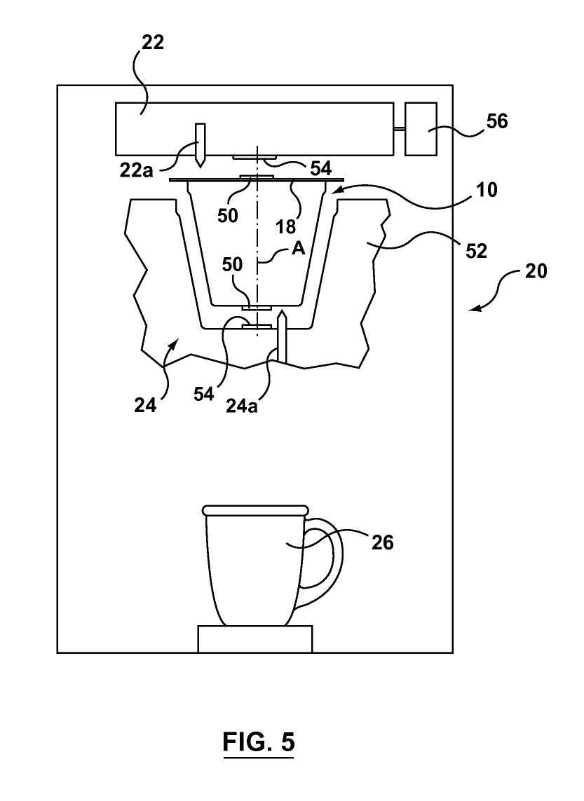

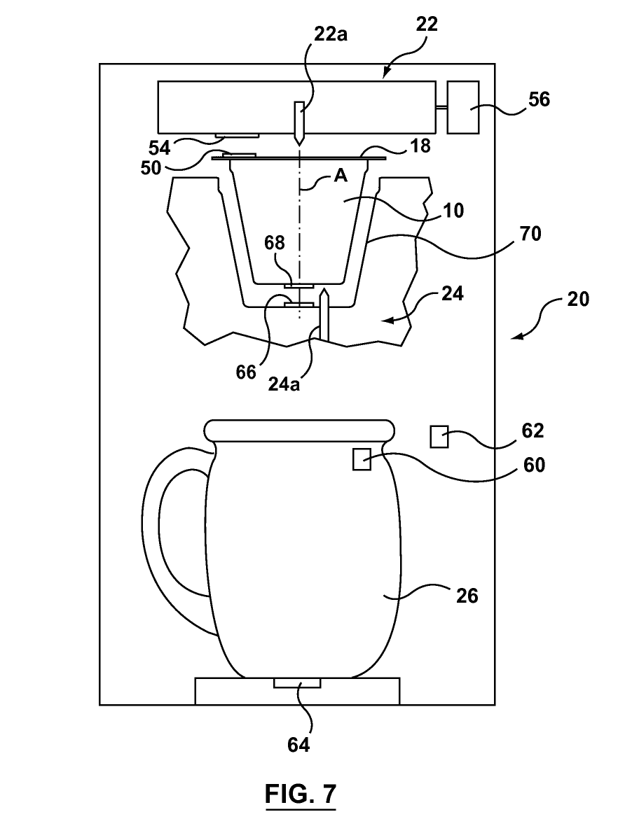

Capsule 10 is sized and configured for use in a machine 20, such as shown in FIGS. 5 and 7, that is adapted for preparing a product from capsule 10. Machine 20 may include an injection system 22 for injecting a fluid, typically heated water, into the capsule for mixing with ingredients 16. Fluid may be injected under high pressure, in order to prepare products such as espresso, or fluid may be injected at lower pressures. Injection system 22 may include a nozzle 22a disposed on machine 20 that is adapted to pierce cover 18 to inject fluid into capsule 10. Injection system 22 may alternatively have at least one component disposed on capsule 10, such as on cover 18, and adapted to pierce body 12 and interact with machine 20 to inject fluid into capsule 10.

Machine may also include a dispensing system 24 for dispensing product from capsule 10 into a desired receptacle 26 such as a bowl or cup. Dispensing system 24 may include a hollow probe 24a that is adapted to pierce capsule 10 to dispense a prepared product from capsule 10.

Body 12 of capsule 10 includes a sidewall 30 and an end wall 32 together defining an interior space 34. An opening 36 is defined at one end of body 12 and a flange 38 extends around the perimeter of opening 36.

In one embodiment, body 12 has a central axis A and preferably a generally uniform shape in cross section. Preferably body 12 is circular in horizontal cross section but other generally uniform shapes may be utilized such as an equilateral triangle, square, equilateral pentagon, hexagon etc. Body 12 is preferably uniformly tapered along at least a portion of central axis A.

In other embodiments, body 12 may have structural features that act as a keying system to orient body 12 in a desired manner when loaded into capsule machine 20. Structural features may include one or more spouts formed into sidewall 30 of body 12 or keys or keyways (protrusions or depressions) formed into end wall 32 of body 12.

Filter 14 is adapted to be disposed within body 12 to define at least one ingredients chamber within interior space 34 for receiving one or more ingredients 16 and in particular insoluble ingredients 16. Filter 14 may be secured to flange 38 or to an interior surface of capsule 10 (such as to sidewall 30). Capsule 10 may be provided without filter 14 in instances where ingredients are soluble or where it is desired that insoluble ingredients 16 are dispensed together with fluid into receptacle 26 (this requires that dispensing system be adapted to dispense insoluble ingredients 16).

Cover 18 is disposed over opening 36 and secured to body 12 such as by sealing cover 18 directly to flange 38 or indirectly with a portion of filter 14 located between.

At least one visual tag 50 is disposed on a portion of capsule 10 that is visible to one or more visual tag readers 54 disposed on capsule machine 20 once capsule 10 is loaded into capsule machine 20 (note visual tag 50 may not necessarily be visible to a human eye as long as it is visible to reader 54).

In the case of capsules 10 having a central axis and no structural features that act as a keying system, visual tag 50 preferably intersects or surrounds central axis A in a manner that visual tag 50 may be read by reader 54 regardless of the orientation of capsule 10 in machine 20. Referring to FIG. 5, visual tag 50 is disposed on cover 18 of capsule 10 in a position that intersects with central axis A and reader 54 is disposed on injection system 22 in a position that aligns with central axis A. In this instance, injection nozzle 22a of injection system 22 is offset from central axis A. Visual tag 50 and reader 54 or also shown in an alternate position on end wall of capsule 10 and a brew chamber 52 for machine 20.

Visual tag 50 may for example be disposed on one or more of cover 18, side wall 30 or end wall 32. Visual tag 50 may be disposed on an interior portion of capsule 10 at a location that is adapted to be read by reader 54 upon piercing of capsule 10 by injection system 22 or dispensing system 24. Preferably, visual tag 50 has little or no visibility to the human eye under normal light conditions and/or it occupies a minimal amount of surface area on cover 18 of capsule 10. More preferably, visual tag 50 comprises a disc 50a or a ring 50b that is less than 5 millimeters at its widest dimension and most preferably less than 3 millimeters. Even more preferably, one or more visual tags 50 may be disposed as a ring 50b occupying an orbit in the outer 50% of the surface area of cover 18 relative to central axis A to align with reader 54.

In the case of capsules having structural features that act as a keying system to orient capsule 10 within machine 20, visual tag 50 may be disposed at a distinct location on capsule 10 that is adapted to align with reader 54 once capsule 10 is loaded into machine 10. Again, it is preferable that visual tag 50 has little or no visibility to a human eye under normal light conditions and/or it occupies a minimal amount of surface area on cover 18 of capsule 10 as described above.

Visual tag 50 is adapted to contain information that may be read by a reader 54 that is disposed on capsule machine 20. Visual tag 50 may comprise one or more of a barcode, a QR code, a bokode, a data matrix (as depicted in FIG. 4), a hologram, a tagged image (such as an Aura™ provided through Aurasma™, microdots, fluorescent compounds or other chemical marking agents that have little or no visibility to a human eye under normal light conditions (such as disclosed in U.S. Pat. No. 8,590,800 incorporated in its entirety herein by reference) or other suitable subject matter that is adapted to be read by a reader 54.

Preferably, visual tag 50 may be produced in the same operation as production of the labeling text, graphics or other imagery for capsule 10 without significantly increasing the cost for producing capsule 10. Most preferably, visual tag 50 is not readily visible to the naked eye. In other words, preferably visual tag 50 is embedded within or part of the graphics, text or other imagery for capsule 10. For example, a visual tag 50 comprising fluorescent compounds or other chemical marking agents would not be readily visible to the naked eye under normal light conditions but could be visible to the naked eye when visual tag 50 is exposed to a specific wavelength of light such as UV or IR light.

Reader 54 is in communication with a controller 56 disposed on capsule machine for processing information identified by reader 54 and controlling the operation of capsule machine 20 in accordance with the identified information. Operational controls may include controlling the temperature, pressure or flow of fluid, monitoring the amount of capsules used by capsule machine or rejecting capsules that do not meet the capsule machine requirements.

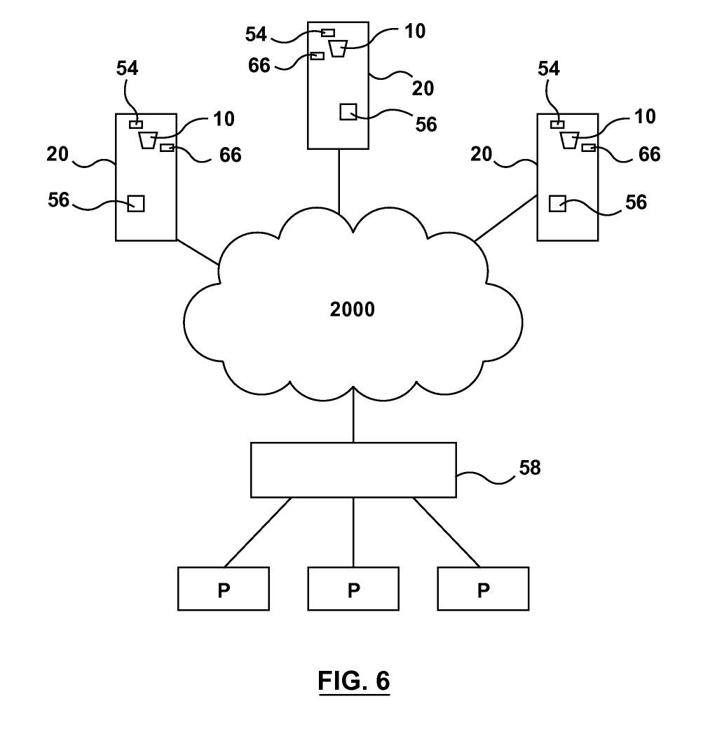

Referring to FIG. 6, controller 56 of machine 20 may be connected to a remote server 58 via Bluetooth, wifi, a wired connection or other electronic communication methods via a communications network 2000 such as the Internet in order to permit information to be exchanged with remote server 58. One or more remote servers 58 may be in communication with a plurality of machines 20. Remote servers 58 may also be in communication with a plurality of interested parties P that are in a position to provide or receive information concerning capsules 10 or machine 20 via the remote server 58 to the controller 56 of one or more machines 20. Information provided to machine 20 may include expiry date, health or safety recalls, contest winners etc regarding a specific capsule 10 or batch of capsules 10. Information provided to interested parties P may include capsule type, batch number, consumption rate, machine analytics or other capsule or machine data.

This allows controller 56 to act as a “smart” controller 56 in relation to information obtained from visual tags 50 on capsules 10. This allows controller 56 to identify capsules 10 that may be past their expiry date, subject to a health or safety recall or that may be winners in a consumer contest.

Referring to FIG. 7, a machine 20 in accordance with another embodiment of the present invention is shown. The same reference numerals are provided for elements that are similar to the elements described above.

Machine 20 includes one or more receptacles 26 having a visual tag 60 that contains information concerning the volume or other characteristics of receptacle 26. Visual tag 60 may comprise any of the forms of visual tag 50 as described above. Visual tag 60 is adapted to be read by a reader 62 disposed on machine 20. Reader 62 is in communication with controller 56 for controlling operation of machine 20. Reader 62 may thus determine that receptacle 26 is not suitable for preparing a product from the specific type of capsule 10 that is disposed in machine 20 as identified by reader 54. For example, capsule 10 may be identified by reader 54 as requiring a large volume of fluid (such as a capsule sized for producing a carafe of coffee) and receptacle 26 may be identified by reader 62 as having insufficient volume to contain the required volume of fluid. As a result, controller 56 may be adapted to reject capsule 10 until the capsule 10 and receptacle 26 characteristics match.

Machine 20 may further include a sensor 64, such as a proximity sensor, that is adapted to sense that receptacle 26 is in a position for receiving product dispensed from capsule 10. Sensor 64 is in communication with controller 56 for controlling operation of machine 20. If sensor 64 senses that receptacle 26 is not in a position for receiving product then it may communicate this information to controller 56 which in turn will refrain from operating machine until receptacle 26 is put into its required position.

Machine may further include a reader 66 that is adapted to read a visual tag 68 located on an outer surface of capsule 10. Visual tag 68 may include information concerning the manufacturing source, manufacturing date, expiry date and batch characteristics, such as an ingredients listing, for capsule 10. Visual tag 68 may include a code of characters that are printed, etched or otherwise disposed on capsule 10 during the process of manufacturing capsule 10. Visual tag 68 may not necessarily be visible to a human eye as long as it is visible to reader 66. In the case of capsules 10 having a central axis and no structural features that act as a keying system, visual tag 68 preferably intersects or surrounds central axis A in a manner that visual tag 68 may be read by reader 66 regardless of the orientation of capsule 10 in machine 20. For example, visual tag 68 may be disposed on the outer surface of endwall 32 of capsule 10 along central axis A and reader 66 may be disposed centrally on a brew chamber 70 for machine 20 in order to align with visual tag 68 on central axis A.

Reader 66 may be an optical reader or other suitable reading device for reading the information contained in visual tag 68. Reader 66 is in communication with controller 56 for controlling operation of machine 10. Controller 56 may in turn be connected to a remote server 58 as described above in order to permit information to be exchanged between one or more machines 20 and one or more interested parties P via one or more remote servers 58.

While the above description provides examples of one or more processes or apparatuses, it will be appreciated that other processes or apparatuses may be within the scope of the accompanying claims.

I/We claim:

1. A capsule, for use in a machine for preparing consumable products from capsules, said capsule comprising:
a body defining an interior space with an opening;
ingredients disposed in said interior space for preparing a desired product;
a cover disposed over said opening; and
a visual tag disposed on at least one of said body and said cover, said visual tag containing information concerning said capsule that may be read by a reader disposed on the machine.

2. The capsule of claim 1, wherein said visual tag is not readily visible to the naked eye.

3. The capsule of claim 1, wherein said visual tag is disposed along a central axis A of capsule 10.

4. The capsule of claim 1 wherein said capsule includes graphics, text or other imagery on at least one of said body and said cover, and wherein said visual tag is embedded within or part of said graphics, text or other imagery.

5. The capsule of claim 1, wherein said visual tag has a width of less than 5 millimeters.

6. The capsule of claim 1, wherein said visual tag is disposed on an interior portion of said capsule.

7. The capsule of claim 1, wherein said capsule includes a plurality of visual tags.

8. The capsule of claim 1 wherein said visual tag includes contest information concerning said capsule.

9. The capsule of claim 1 wherein said visual tag includes expiry date information concerning said capsule.

10. The capsule of claim 1 wherein said visual tag includes manufacturing information for said capsule.

11. The capsule of claim 10, wherein said manufacturing information includes one or more of manufacturing source, manufacturing date, expiry date and batch characteristics, such as an ingredients listing.

12. The capsule of claim 1 wherein said visual tag includes a code of characters that are disposed on said capsule during the process of manufacturing.

13. A capsule machine for preparing consumable products from capsules, said capsule machine comprising:
a brew chamber adapted to receive a capsule;
a reader adapted for reading a visual tag disposed on a capsule when said capsule is disposed in said brew chamber;
an injection system for injecting a fluid into said capsule;
a controller for controlling said injection system, said controller being in communication with said reader for receiving and processing information identified by said reader.

14. The capsule machine of claim 13 wherein said reader is adapted to read a visual tag that is not readily visible to the naked eye.

15. The capsule machine of claim 13 further comprising a controller that is in communication with said reader, said controller being adapted for controlling one or more operations of said machine based on information including information received from said reader.

16. The capsule machine of claim 13 wherein said controller is adapted to communicate with a remote server.

17. The capsule machine of claim 13 wherein said reader is adapted to read a visual tag comprising a code of characters that are disposed on said capsule during the process of manufacturing.

18. The capsule of claim 13 wherein said visual tag includes manufacturing information for said capsule.

19. The capsule machine of claim 178 wherein said manufacturing information includes one or more of manufacturing source, manufacturing date, expiry date and batch characteristics, such as an ingredients listing.

20. The capsule machine of claim 13 further comprising a receptacle that is adapted to receive a consumable product prepared with said machine from a capsule, said receptacle including a visual tag containing information concerning said receptacle and said machine including a reader for reading the visual tag on said receptacle and communicating such information to said controller.

21. The capsule machine of claim 13 wherein said machine includes a sensor for sensing the position of a receptacle that is adapted to receive a consumable product prepared with said machine from a capsule, said sensor communicating such information to said controller.

22. A capsule identification system comprising:
a) a plurality of machines adapted for preparing consumable products from capsules, at least some of said machines including (i) a reader that is adapted to read a visual tag disposed on a capsule and (ii) a controller in communication with said reader, said controller being adapted for controlling one or more operations of said machine based on information including information received from said reader;
b) one or more interested parties that are in a position to provide or receive information concerning said capsules or said machine; and
c) one or more remote servers adapted for communicating information between said plurality of machines and said one or more interested parties.

23. A system as claimed in claim 22, wherein said visual tag on at least some of said capsules is not readily visible to the naked eye.

24. A system as claimed in claim 22 wherein said visual tag on at least some of said capsules includes manufacturing information for said capsule.

25. A system as claimed in claim 22 wherein said visual tag on at least some of said capsules includes contest information concerning said capsule.
